(19) United States
(12) Patent Application Publication
(10) Pub. No.: US 2013/0255849 A1
(43) Pub. Date: Oct. 3, 2013

(54) METHOD OF SETTING A CARRIER TAPE, TAPE CASSETTE, MOUNTING APPARATUS, AND METHOD OF MANUFACTURING A SUBSTRATE

(71) Applicant: SONY CORPORATION, Tokyo (JP)

(72) Inventors: Katsumi Watanabe, Saitama (JP); Togo Matsuura, Saitama (JP); Masataka Koike, Saitama (JP)

(73) Assignee: Sony Corporation, Tokyo (JP)

(21) Appl. No.: 13/847,522

(22) Filed: Mar. 20, 2013

(30) Foreign Application Priority Data
Mar. 27, 2012 (JP) 2012-071786

(51) Int. Cl. B32B 38/00

(52) U.S. Cl. CPC B32B 38/1875
USPC 156/60; 156/538; 226/1; 226/181

(57) ABSTRACT

Provided is a method of setting a carrier tape, the carrier tape including a carrier tape body configured to contain a plurality of electronic components, and a cover tape configured to cover the carrier tape body, the method including: starting rotation of a pair of rollers capable of nipping the cover tape of the carrier tape; and inserting a leading end portion of the cover tape to between the pair of rollers during the rotation so that the cover tape is pulled in by the pair of rollers.

### BACKGROUND

The present technology relates to a technology such as a method of setting a carrier tape, specifically, setting a carrier tape containing a plurality of electronic components to a tape cassette.

In related art, there has been widely known a mounting apparatus configured to mount electronic components such as a resistor, a capacitor, and a coil to a substrate. In general, such a mounting apparatus includes supply units each configured to supply the electronic components, and a mounting head configured to suck the electronic components supplied from the supply units and to mount the sucked electronic components to the substrate.

In general, the supply units are each formed of a plurality of tape cassettes arrayed in a horizontal direction. The tape cassette contains a carrier tape containing a plurality of electronic components of the same type. The tape cassette feeds stepwise the carrier tape to a front side while peeling off a cover tape of the carrier tape. In this way, the electronic components are supplied one by one. The carrier tape is replaceable with respect to the tape cassette so as to be replaced with a new carrier tape when the electronic components in the carrier tape are depleted.

For example, when the tape cassette is used for the first time, or when the carrier tape is replaced with a new carrier tape, first, it is necessary to set the carrier tape to the tape cassette. As a technology relating to the method of setting the carrier tape to the tape cassette, there has been known a technology described in Japanese Patent Application Laid-open No. 2008-91709 (paragraphs [0045] to [0050]) (hereinafter, referred to as Patent Document 1).

In the technology described in Patent Document 1, first, a leading end portion of the carrier tape is pulled out by an amount of an appropriate length from an upper portion of a component supply apparatus. In this state, the cover tape is peeled off from the carrier tape, and the carrier tape is engaged with teeth of a sprocket of the component supply apparatus.

Meanwhile, the cover tape is reversed in an opposite direction with respect to a direction in which the carrier tape is pulled out (reversed to a rear side), and inserted to between a pull-in roller and a pinch roller spaced apart from the pull-in roller. Then, the pinch roller is moved to the pull-in roller side so that the cover tape is nipped between the pull-in roller and the pinch roller. In this way, the cover tape can be pulled in. When the cover tape is pulled to the front side in this state, the pull-in roller and the pinch roller start to be rotated. As a result, slack of the cover tape is removed.

### SUMMARY

However, the technology described in Patent Document 1 is disadvantageous in that operations at the time of setting the carrier tape to the component supply apparatus, in particular, an operation at the time of pulling in the cover tape with the pull-in roller and the pinch roller so as to remove the slack is troublesome. Specifically, in the technology described above, it is necessary to perform the following operations: separating the pinch roller from the pull-in roller; setting the leading end portion of the cover tape between the pull-in roller and the pinch roller; moving back the pinch roller to the pull-in roller side; and pulling the cover tape to the front side. These operations are troublesome to an operator.

In view of the circumstance described above, there is a need to provide a technology such as a method of setting a carrier tape by which a carrier tape can be easily set to a tape cassette.

According to an embodiment of the present technology, there is provided a method of setting a carrier tape, the carrier tape including

a carrier tape body configured to contain a plurality of electronic components, and

a cover tape configured to cover the carrier tape body, the method including:

starting rotation of a pair of rollers capable of nipping the cover tape of the carrier tape; and

inserting a leading end portion of the cover tape to between the pair of rollers during the rotation so that the cover tape is pulled in by the pair of rollers.

According to this method, an operator only has to rotate the pair of rollers, and then insert the leading end portion of the cover tape to between the pair of rollers during the rotation. With this, the cover tape is automatically pulled in by the pair of rollers, and slack of the cover tape is automatically removed. In this way, by the method according to the embodiment of the present technology, the operator can easily set the carrier tape to the tape cassette.

In the method of setting the carrier tape, the starting of the rotation of the pair of rollers may include inserting a first connector of the tape cassette to a second connector of a mounting apparatus, the carrier tape being set to the tape cassette, the tape cassette being set to the mounting apparatus.

According to this method, the pair of roller automatically starts to be rotated when the tape cassette is set to the mounting apparatus and the first connector of the tape cassette is inserted to the second connector of the mounting apparatus.

In the method of setting the carrier tape, the starting of the rotation of the pair of rollers may include operating an operation unit configured to start the rotation of the pair of rollers.

With this, the operator can start the rotation of the pair of rollers by operating the operation unit.

The method of setting the carrier tape may further include stopping the rotation of the pair of rollers when a sensor configured to detect whether or not tension applied to the cover tape has reached a predetermined magnitude or greater detects that the tension applied to the cover tape has reached the predetermined magnitude or greater.

With this, when the sensor detects that the tension applied to the cover tape has reached the predetermined magnitude or greater (slack has been removed), the rotation of the pair of rollers is automatically stopped.

In this way, setting of the carrier tape is automatically completed.

In the method of setting the carrier tape, the stopping of the rotation of the pair of rollers may include stopping the rotation of the pair of rollers after elapse of a predetermined time period after the starting of the rotation of the pair of rollers when the sensor does not detect that the tension applied to the cover tape has reached the predetermined magnitude or greater even after the elapse of the predetermined time period after the starting of the rotation of the pair of rollers.

When the rotation of the pair of roller is started, the operator may not intend to set the cover tape of the carrier tape immediately after the start of the rotation.

In the mounting apparatus described above, when the sensor detects that the tension applied to the cover tape has reached the predetermined magnitude or greater (slack has been removed), the rotation of the pair of rollers is stopped. Thus, when no measure is taken, the pair of rollers is endlessly rotated in a case where the operator does not intend to set the cover tape of the carrier tape immediately after the start of the rotation of the pair of rollers. As a result, electric power is wasted. As a countermeasure, in this method, the rotation of the pair of rollers is stopped when the sensor does not detect that the tension applied to the cover tape has reached the predetermined magnitude or greater even after the elapse of the predetermined time period after the starting of the rotation of the pair of rollers. With this, electric power can be saved.

In the method of setting the carrier tape, the inserting of the leading end portion of the cover tape to between the pair of rollers during the rotation so that the cover tape is pulled in by the pair of rollers may include inserting the leading end portion of the cover tape to between the pair of rollers during the rotation through intermediation of a restricting member configured to restrict direct manual access by the operator with respect to the pair of rollers during the rotation.

In this method, the restricting member restricts the direct manual access by the operator with respect to the pair of rollers during the rotation, and hence safety for the hand of the operator can be secured.

According to an embodiment of the present technology, there is provided a tape cassette including a pair of rollers.

The pair of rollers is capable of nipping a cover tape of a carrier tape including

a carrier tape body configured to contain a plurality of electronic components, and

the cover tape configured to cover the carrier tape body.

A leading end portion of the cover tape is inserted to between the pair of rollers during rotation so that the inserted cover tape is pulled in.

The tape cassette may further include a first connector and a control unit.

The first connector is configured to be inserted to a second connector of a mounting apparatus to which the tape cassette is set.

The control unit is configured to start the rotation of the pair of rollers when the first connector is inserted to the second connector.

The tape cassette may further include an operation unit configured to start the rotation of the pair of rollers.

The tape cassette may further include a sensor and a control unit.

The sensor is configured to detect whether or not tension applied to the cover tape has reached a predetermined magnitude or greater.

The control unit is configured to stop the rotation of the pair of rollers when the sensor detects that the tension applied to the cover tape has reached the predetermined magnitude or greater.

In the tape cassette, the control unit may stop the rotation of the pair of rollers after elapse of a predetermined time period after starting of the rotation of the pair of rollers when the sensor does not detect that the tension applied to the cover tape has reached the predetermined magnitude or greater even after the elapse of the predetermined time period after the starting of the rotation of the pair of rollers.

The tape cassette may further include a restricting member configured to restrict direct manual access by an operator with respect to the pair of rollers during the rotation.

According to an embodiment of the present technology, there is provided a mounting apparatus including a tape cassette including a pair of rollers.

The pair of rollers is capable of nipping a cover tape of a carrier tape including

a carrier tape body configured to contain a plurality of electronic components, and

the cover tape configured to cover the carrier tape body.

A leading end portion of the cover tape is inserted to between the pair of rollers during rotation so that the inserted cover tape is pulled in.

According to an embodiment of the present technology, there is provided a method of manufacturing a substrate, including:

starting rotation of a pair of rollers capable of nipping a cover tape of a carrier tape including
a carrier tape body configured to contain a plurality of electronic components, and
the cover tape configured to cover the carrier tape body, and

inserting a leading end portion of the cover tape to between the pair of rollers during the rotation so that the cover tape is pulled in by the pair of rollers, to thereby supply the plurality of electronic components from the carrier tape set to a tape cassette; and

mounting the plurality of supplied electronic components to the substrate.

As described above, according to the embodiments of the present technology, it is possible to provide a technology such as a method of setting a carrier tape by which a carrier tape can be easily set to a tape cassette.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a front view of a mounting apparatus according to an embodiment of the present technology;

FIG. 2 is a top view of the mounting apparatus illustrated in FIG. 1;

FIG. 3 is a block diagram of a configuration of the mounting apparatus;

FIG. 4 is a schematic side view of a tape cassette according to the embodiment of the present technology;

FIG. 5 is an enlarged side view of a tensioner and a sensor of the tape cassette;

FIG. 6 is another enlarged side view of the tensioner and the sensor of the tape cassette;

FIG. 7 is still another enlarged side view of the tensioner and the sensor of the tape cassette;

FIG. 8 is a perspective view of a restricting member of the taper cassette;

FIG. 9 is another perspective view of the restricting member of the taper cassette; and

FIG. 10 is a perspective view of a carrier tape to be set to the taper cassette.

### DETAILED DESCRIPTION OF EMBODIMENTS

Hereinafter, embodiments of the present technology will be described with reference to the drawings.

### First Embodiment

[Structures of Mounting Apparatus 100 and Units Thereof]

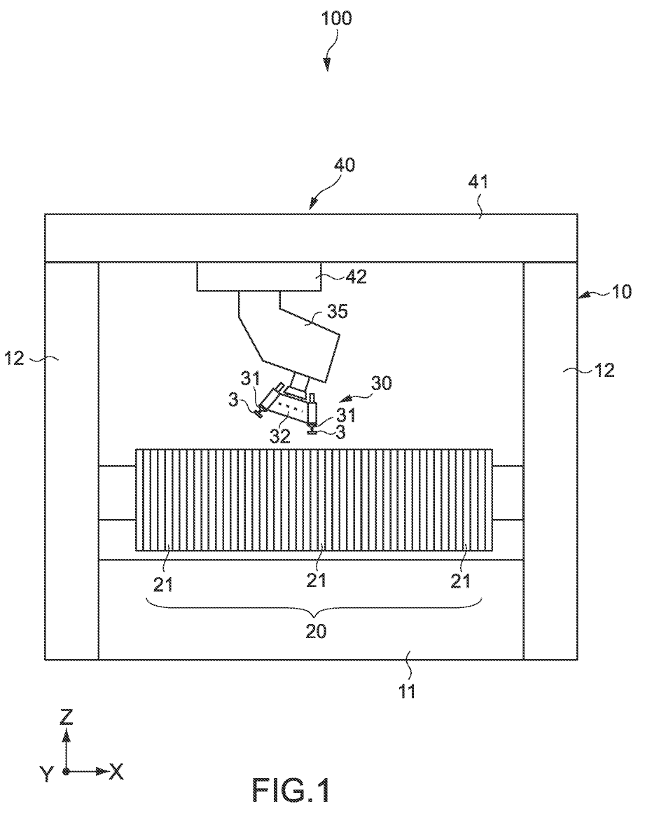

FIG. 1 is a front view of a mounting apparatus 100 according to a first embodiment of the present technology.

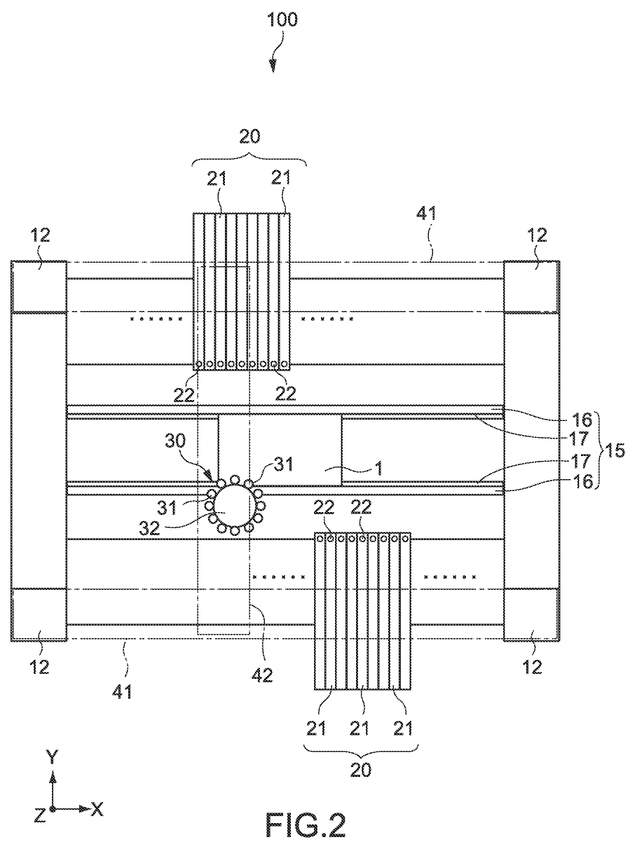

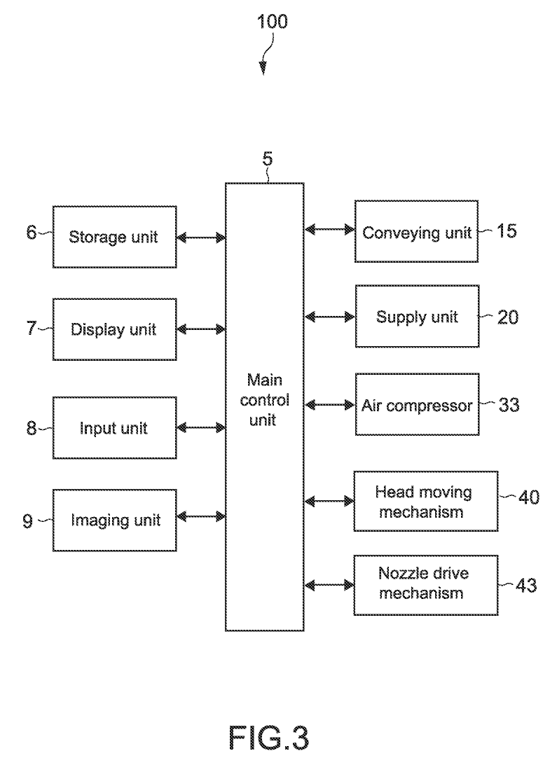

FIG. 2 is a top view of the mounting apparatus 100 illustrated in FIG. 1. FIG. 3 is a block diagram of a configuration of the mounting apparatus 100.

As illustrated in FIGS. 1 and 2, the mounting apparatus 100 includes a frame structural body 10, a conveying unit 15 provided to the frame structural body 10 and configured to convey a substrate 1 in an X-axis direction, and supply units 20 provided on both sides in a Y-axis direction of the conveying unit 15 and configured to supply electronic components 3. Further, the mounting apparatus 100 includes a mounting head 30 configured to suck the electronic components 3 supplied from the supply units 20 and to mount the sucked electronic components 3 to the substrate 1, and a head moving mechanism 40 configured to move the mounting head 30 in both the X-axis direction and the Y-axis direction.

As illustrated in FIG. 3, the mounting apparatus 100 further includes a main control unit 5, a storage unit 6, a display unit 7, an input unit 8, an imaging unit 9, an air compressor 33, and a nozzle drive mechanism 43.

The conveying unit 15 includes a pair of guides 16 arranged along the X-axis direction, and a pair of conveyers 17 provided on a central side with respect to the pair of guides 16. The conveying unit 15 is driven by the pair of conveyers 17 so as to carry-in and position the substrate 1 to a predetermined position, and to driver the substrate 1 mounted with the electronic components 3.

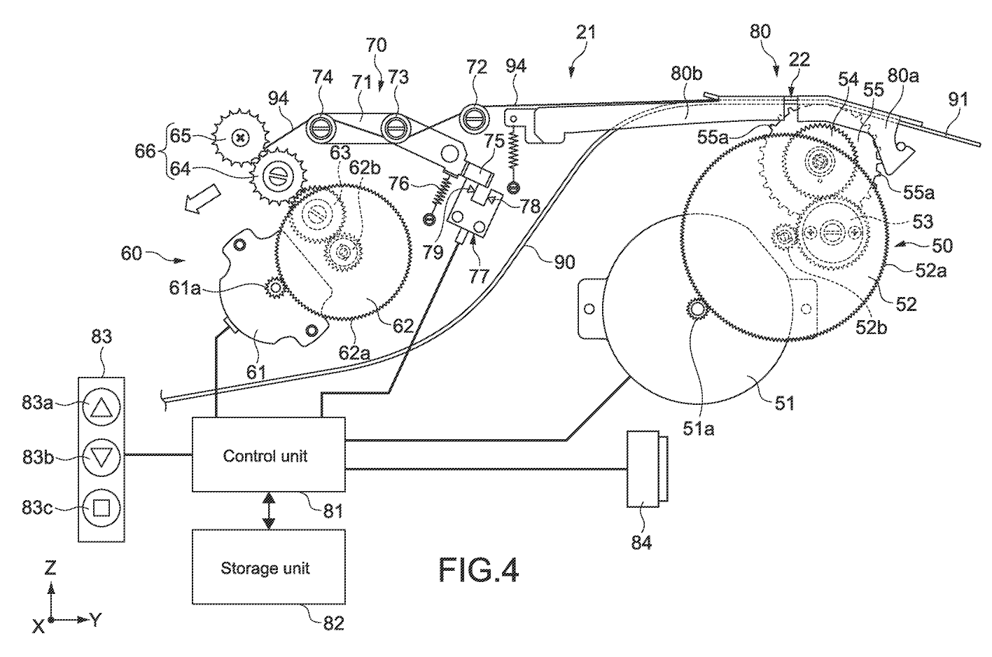

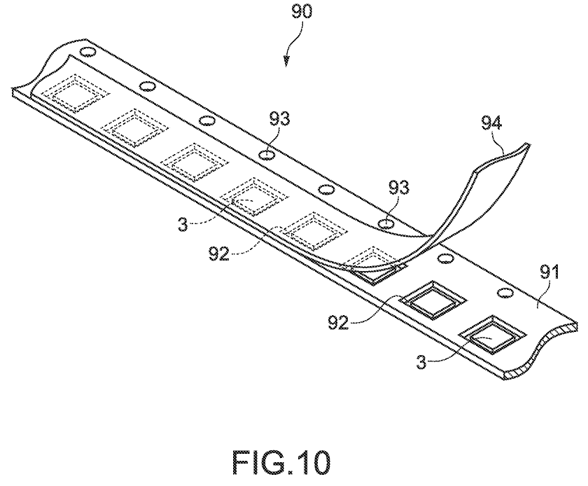

The supply units 20 are each formed of a plurality of tape cassettes 21 arrayed along the X-axis direction. These tape cassettes 21 are detachable with respect to the mounting apparatus 100, and each contain a carrier tape 90 (refer to FIG. 10) rolled up therein. The carrier tape 90 contains the plurality of electronic components 3 of the same type, such as a resistor, a capacitor, a coil, and an integrated circuit (IC) chip. A supply window 22 is formed in an upper surface at an end portion of each of the tape cassettes 21, and the electronic components 3 are supplied through the supply window 22. Description of the structure of each of the tape cassettes 21 and the structure of carrier tape 90 is made below with reference to FIGS. 4 to 10.

The frame structural body 10 includes a base 11 provided at and end portion thereof, and a plurality of support posts 12 fixed to the base 11.

The head moving mechanism 40 includes two X-beams 41 bridged along the X-axis direction between top portions of the plurality of support posts 12, and a Y-beam 42 bridged along the Y-axis direction between the two X-beams 41. Note that, in FIG. 2, for the sake of better visibility, the X-beams 41 and the Y-beam 42 on the top portion side are indicated by dashed lines.

The Y-beam 42 is attached to be movable under the two X-beams 41 in the X-axis direction with respect to the X-beams 41. The X-beams 41 each incorporates an X-axis drive mechanism configured to move the Y-beam 42 along the X-axis direction. The X-axis drive mechanism is driven to move the Y-beam 42 under the X-beams 41 along the X-axis direction.

A carriage 35 configured to hold the mounting head 30 is attached under the Y-beam 42. The carriage 35 is attached to be movable in the Y-axis direction with respect to the Y-beam 42. The Y-beam 42 incorporates a Y-axis drive mechanism configured to move the carriage 35 along the Y-axis direction. The Y-axis drive mechanism is driven to move the carriage 35 under the Y-beam 42 along the Y-axis direction.

The mounting head 30 includes a turret 32 attached to be rotatable with respect to the carriage 35, and a plurality of suction nozzles 31 attached to the turret 32 at equal intervals along a circumferential direction of the turret 32.

The turret 32 is rotatable about an oblique rotation center axis. The suction nozzles 31 are attached to the turret 32 in a manner that an axial line of each of the suction nozzles 31 is inclined with respect to the rotation axis of the turret 32.

The suction nozzles 31 are supported to be movable along directions of the respective axial lines (upper and lower directions) with respect to the turret 32. Further, the suction nozzles 31 are supported to be rotatable with respect to the turret 32. The nozzle drive mechanism 43 (refer to FIG. 3) is driven to move the suction nozzles 31 along the directions of the respective axial lines at a predetermined timing, or rotate the suction nozzles 31 about the respective axial lines.

Of the plurality of suction nozzles 31, an axial line of a lowermost one of the suction nozzles 31 (rightmost one of the suction nozzles 31 in FIGS. 1 and 2) is directed to a perpendicular direction (Z-axis direction). In the following, a position at which the axial line of one of the suction nozzles 31 is directed to the perpendicular direction is referred to as an operation position.

The suction nozzle 31 at the operation position is moved in the upper and lower directions so as to suck the electronic component 3 supplied through the supply window 22. Further, the suction nozzle 31 at the operation position is moved in the upper and lower directions so as also to mount the electronic component 3 sucked by the suction nozzle 31 to the substrate 1. The suction nozzle 31 at the operation position is sequentially switched by rotation of the turret 32.

The suction nozzles 31 are connected to the air compressor 33 (refer to FIG. 3). The suction nozzle 31 is capable of sucking and releasing the electronic component 3 by switchover between a negative pressure and a positive pressure of the air compressor 33.

Although the mounting head 30 exemplified in this embodiment is of a turret rotation type, the mounting head 30 may be of any type. For example, the plurality of suction nozzles 31 of the mounting head 30 may be arrayed in parallel to each other.

The main control unit 5 is formed, for example, of a central processing unit (CPU). The main control unit 5 is electrically connected to the units of the mounting apparatus 100, and generally controls the units of the mounting apparatus 100 based on various programs stored in the storage unit 6.

The storage unit 6 includes a nonvolatile memory storing the various programs necessary for controlling the main control unit 5, and a volatile memory used as a work area for the main control unit 5. The various programs may be loaded from portable recording media such as an optical disk and a semiconductor memory.

The display unit 7 is formed of a liquid crystal display, an electro-luminescence (EL) display, or the like, and displays various data items on the screen. The input unit 8 is formed, for example, of a keyboard or a touch panel, and receives instructions from an operator.

The imaging unit 9 include various imaging units 9 such as an imaging unit 9 configured to image an alignment mark provided on the substrate 1, and an imaging unit 9 configured to image the electronic component 3 held by the suction nozzle 31 from sideways or below. The imaging unit 9 is attached, for example, to the carriage 35 so as to be moved integrally with the carriage 35 and the mounting head 30 when the carriage 35 and the mounting head 30 are moved along the X-axis direction or the Y-axis direction.

Various processes are executed based on the image obtained by the imaging unit 9. For example, based on the image of the alignment mark provided on the substrate 1, a mounting position of the electronic component 3 is corrected. Alternatively, based on the image of the electronic component 3 held by the suction nozzle 31, whether or not suction of the electronic component 3 has failed is judged, or at which position the electronic component 3 is sucked by the suction nozzle 31 is judged.

[Structure of Tape Cassette 21 and Structure of Carrier Tape 90]

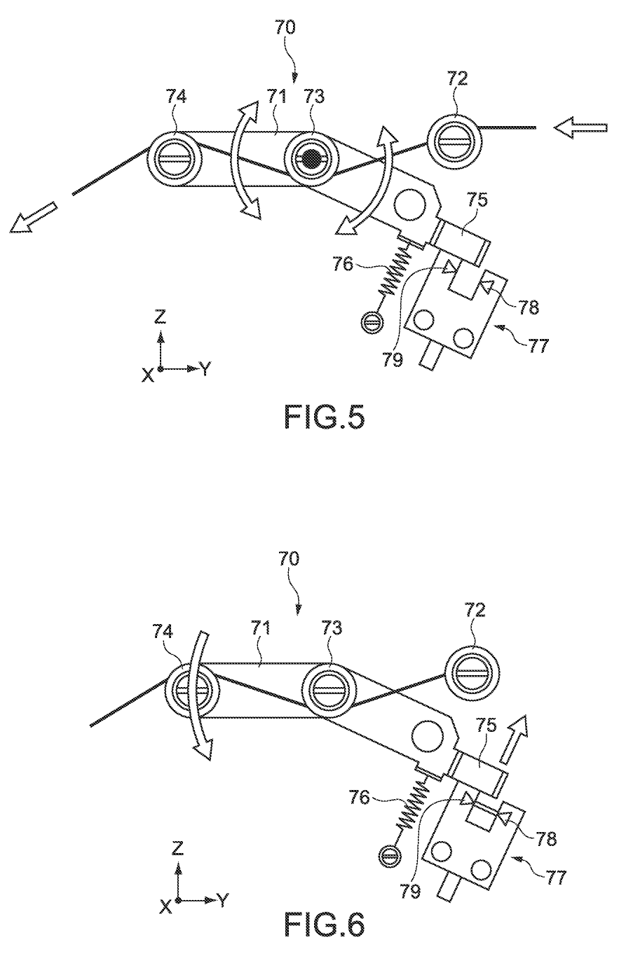

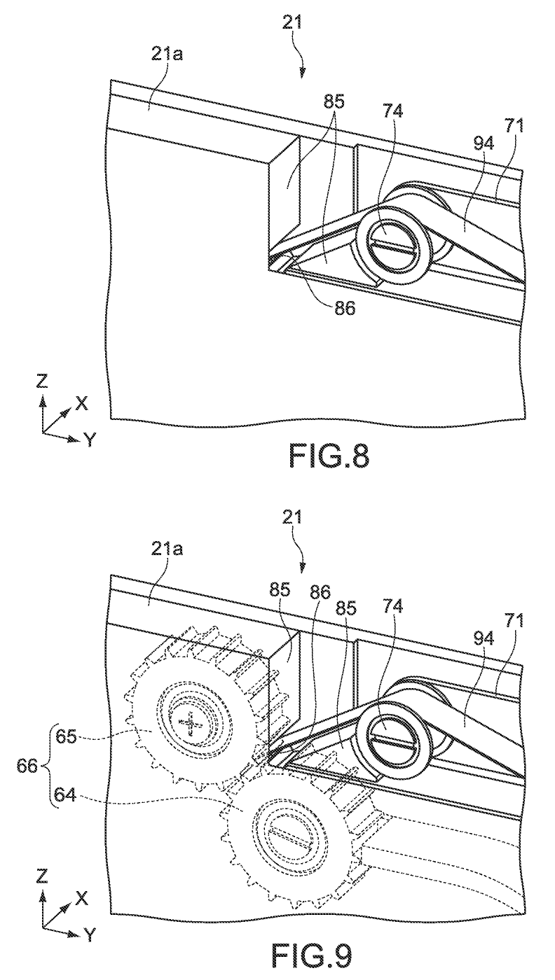

Next, detailed description is made of the structure of the tape cassette 21. FIG. 4 is a schematic side view of the tape cassette 21. FIGS. 5 to 7 are each an enlarged side view of a tensioner 70 and a sensor 77 of the tape cassette 21. FIGS. 8 and 9 are each a perspective view of a restricting member 85 of the taper cassette 21. FIG. 10 is a perspective view of the carrier tape 90 to be set to the taper cassette 21.

As illustrated in FIG. 10, the carrier tape 90 to be set to the tape cassette 21 includes a carrier tape body 91 configured to contain the plurality of electronic components 3 of the same type, and a cover tape 94 configured to cover the carrier tape body 91. The carrier tape 90 is rolled up around a reel and contained in the tape cassette 21.

The carrier tape body 91 is provided with a plurality of recesses 92 which are formed along a longitudinal direction of the carrier tape 90 and configured to contain the electronic components 3. Further, along one side of the carrier tape body 91, there are formed engagement holes 93 formed therethrough in the upper and lower directions. The engagement holes 93 are engaged with teeth 55a of a sprocket 55 (described below) of the tape cassette 21.

The cover tape 94 is bonded to an upper surface of the carrier tape body 91, and can be peeled off from the upper surface of the carrier tape body 91 by application of a force of a predetermined magnitude or greater.

As illustrated in FIGS. 4 to 9, the tape cassette 21 includes a tape cassette body 21a, a feed mechanism 50, a pull-in mechanism 60, the tensioner 70, the sensor 77, a tape holder 80, a control unit 81, a storage unit 82, an operation unit 83, and a first connector 84.

As illustrated in FIG. 4, the feed mechanism 50 is provided in an upper portion on a front side of the tape cassette 21 (right side of FIG. 4) so as to feed stepwise the carrier tape 90. The feed mechanism 50 includes a feeding motor 51, a first gear 52, a second gear 53, a third gear 54, and the sprocket 55 formed integrally with the third gear 54.

A gear 51a is attached to an output shaft of the feeding motor 51, and meshed with a large gear 52a formed along an outer peripheral surface of the first gear 52. The first gear 52 includes not only the large gear 52a but also a small gear 52b coaxial with the large gear 52a, and the small gear 52b is meshed with the second gear 53.

The second gear 53 is meshed not only with the small gear 52b of the first gear 52 but also with the third gear 54. The teeth 55a of the sprocket 55 formed integrally with the third gear 54 are engaged with the engagement holes 93 provided through the carrier tape body 91.

The pull-in mechanism 60 is provided in an upper portion on a rear side of the tape cassette 21 (left side of FIG. 4) so as to pull in the cover tape 94 of the carrier tape 90. The pull-in mechanism 60 includes a pulling-in motor 61, a first gear 62, a second gear 63, and a pair of pull-in rollers 66.

In the following description, when it is necessary to make specific distinctions between two rollers of the pair of pull-in rollers 66, one of the pull-in rollers is referred to as a first pull-in roller 64 and the other of the pull-in rollers is referred to as a second pull-in roller 65.

A gear 61a is attached to an output shaft of the pulling-in motor 61, and meshed with a large gear 62a formed along an outer peripheral surface of the first gear 62. The first gear 62 includes not only the large gear 62a but also a small gear 62b coaxial with the large gear 62a, and the small gear 62b is meshed with the second gear 63. The second gear 63 is meshed with the first pull-in roller 64. The second pull-in roller 65 is meshed with the first pull-in roller 64, and is rotated together with the first pull-in roller 64 along with rotation of the first pull-in roller 64.

In the illustration, the pair of pull-in rollers 66 is provided in a form of having a plurality of teeth, that is, provided in a form of a gear. However, these teeth are not necessarily provided, and may be omitted.

The pair of pull-in rollers 66 is capable of nipping the cover tape 94 of the carrier tape 90. In order to set the cover tape 94 of the carrier tape 90, a leading end of the cover tape 94 is inserted to between the pair of pull-in rollers 66 during rotation so that the cover tape 94 is pulled in. In this way, slack of the cover tape 94 is removed. Further, after the cover tape 94 is set once, the pair of pull-in rollers 66 pulls in the cover tape 94 to the rear side while preventing the slack of the cover tape 94. The cover tape 94 pulled in by the pair of pull-in rollers 66 is delivered to a cover tape delivery unit (not shown) arranged on the rear side with respect to the pull-in mechanism 60.

As illustrated in FIGS. 4 to 7, the tensioner 70 is provided between the feed mechanism 50 and the pull-in mechanism 60. The tensioner 70 peels off the cover tape 94 from the carrier tape body 91 while maintaining predetermined tension applied to the cover tape 94. The tensioner 70 includes a tensioner body 71 formed to be bent at a position near a center thereof, and three guide rollers (first guide roller 72, second guide roller 73, and third guide roller 74) configured to guide the cover tape 94. Further, the tensioner 70 includes a sensor dog 75 attached to one end side of the tensioner body 71, and a spring member 76 provided at a lower position on the one end side of the tensioner body 71 and configured to pull the tensioner body 71 downward.

The tensioner body 71 is turnable about a center axis at a position near a center thereof (position at which the second guide roller 73 is provided).

Of the three rollers, the first guide roller 72 positioned on the front side is attached to the tape cassette body 21a. Meanwhile, of the three rollers, the second guide roller 73 positioned between the first guide roller 72 and the third guide roller 74, and the third guide roller 74 positioned on the rear side are attached to the tensioner body 71. The second guide roller 73 is provided at a position of the turning axis of the tensioner body 71 near the center of the tensioner body 71. The third guide roller 74 is provided at an end portion on an opposite side with respect to the tensioner body 71, on which the sensor dog 75 and the spring member 76 are provided.

The cover tape 94 is guided to between the pair of pull-in rollers 66 via an upper side of the first guide roller 72, a lower side of the second guide roller 73, and an upper side of the third guide roller 74. The spring member 76 pulls downward the tensioner body 71 so that the cover tape 94 can be peeled off from the carrier tape body 91.

The sensor 77 detects, in accordance with movement of the sensor dog 75 moved integrally with the tensioner body 71, whether or not tension applied to the cover tape 94 has reached a predetermined magnitude or greater (whether or not the tape slack has been removed). Examples of the sensor 77 include a photo interrupter formed of a light emitting portion 78 and a light receiving portion 79 arranged to face each other.

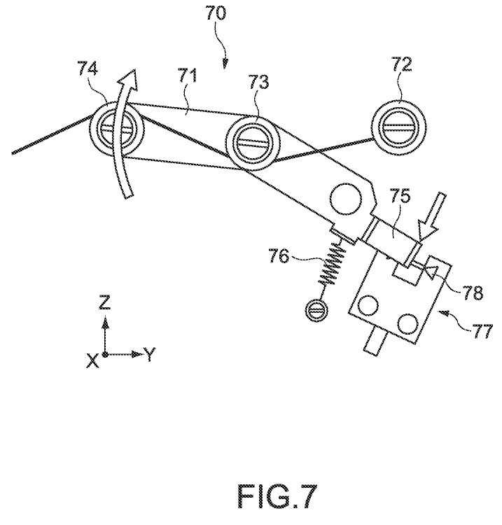

As illustrated in FIGS. 5 and 6, as long as the tension of a predetermined magnitude or greater is applied to the cover tape 94, the sensor dog 75 does not exist between the light emitting portion 78 and the light receiving portion 79 of the sensor 77, and hence a light beam emitted from the light emitting portion 78 is not interrupted by the sensor dog 75. In this case, the light beam emitted from the light emitting portion 78 is received by the light receiving portion 79. Meanwhile, as illustrated in FIG. 7, as long as the tension of a predetermined magnitude or greater is not applied to the cover tape 94, the sensor dog 75 exists between the light emitting portion 78 and the light receiving portion 79 of the sensor 77, and hence the light beam emitted from the light emitting portion 78 is interrupted by the sensor dog 75. In this case, the light beam emitted from the light emitting portion 78 is not received by the light receiving portion 79. The control unit 81 is capable of recognizing whether or not appropriate tension has been applied to the cover tape 94 based on switchover between a light reception mode and a non light reception mode of the sensor 77.

As illustrated in FIG. 4, the tape holder 80 fits onto the carrier tape 90 so as to prevent the carrier tape 90 from bulging and to maintain engagement between the carrier tape 90 and the sprocket 55. The tape holder 80 includes a first tape holder 80a on the front side and a second tape holder 80b on the rear side. The supply window 22 through which the electronic components 3 are supplied is formed in a region between the first tape holder 80a and the second tape holder 80b. The cover tape 94 is reversed at a position near a front end portion of the second tape holder 80b, in other words, at a position on the rear side with respect to the supply window 22, and guided to the tensioner 70 side.

The first connector 84 is provided, for example, on the front side of the tape cassette 21. The first connector 84 is attached and detached with respect to a second connector (not shown) provided on the mounting apparatus 100 side in accordance with insertion and ejection of the tape cassette 21 with respect to the mounting apparatus 100. When the first connector 84 is connected to the second connector, the first connector 84 transmits electric power supplied from the mounting apparatus 100 side, and control signals input from the main control unit 5 on the mounting apparatus 100 side.

The control unit 81 is formed, for example, of a CPU. The control unit 81 is connected electrically to portions of the tape cassette 21, and generally controls the portions of the tape cassette 21 based on various programs stored in the storage unit 82. Typically, the control unit 81 controls the portions of the tape cassette 21 cooperatively with the main control unit 5 on the mounting apparatus 100 side.

The storage unit 82 includes a nonvolatile memory storing the various programs necessary for controlling the control unit 81, and a volatile memory used as a work area for the control unit 81. The various programs may be loaded from portable recording media such as an optical disk and a semiconductor memory.

The operation unit 83 includes a rotation button 83a configured to rotate the sprocket 55 of the feed mechanism 50 and the pair of pull-in rollers 66 of the pull-in mechanism 60 by a predetermined rotational amount in a forward direction, and another rotation button 83b configured to rotate the sprocket 55 and the pair of pull-in rollers 66 by a predetermined rotational amount in a reverse direction. Further, the operation unit 83 includes a roller rotation button 83c configured to allow only the pair of pull-in rollers 66 of the pull-in mechanism 60 to start to be manually rotated in the forward direction.

As illustrated in FIGS. 8 and 9, the tape cassette body 21a is provided with the restricting member 85. When an operator sets the cover tape 94 to the tape cassette 21 so that the cover tape 94 is pulled in by the pair of pull-in rollers 66, the restricting member 85 restricts direct manual access by the operator with respect to the pair of pull-in rollers 66 during rotation.

The restricting member 85 is formed of a cover member 85 configured to cover the pair of pull-in rollers 66 on the front side with respect to the pair of pull-in rollers 66. The cover member 85 is provided with an insertion port 86 formed at a position between the first pull-in roller 64 and the second pull-in roller 65 and configured to allow the cover tape 94 to be inserted. By provision of the restricting member 85, the fingers of the operator are prevented from being caught between the pair of pull-in rollers 66 during rotation.

[Description of Operation]

[How Tape Cassette 21 Supplies Electronic Components 3]

First, description is made of how the tape cassette 21 supplies the electronic components 3 contained in the carrier tape 90 to the mounting head 30 of the mounting apparatus 100. This operation is executed after an operation of setting the carrier tape 90 (described below) has been completed.

First, in response to an instruction of supplying the electronic component 3 from the main control unit 5 on the mounting apparatus 100 side, the control unit 81 controls the feeding motor 51 so as to rotate the feeding motor 51 by a predetermined rotational amount. When the feeding motor 51 is rotated, the rotation of the feeding motor 51 is transmitted to the sprocket 55 through intermediation of the first gear 52, the second gear 53, and the third gear 54. During the transmission to the sprocket 55, the rotation of the feeding motor 51 is slowed down by the first gear 52. With this, the rotational amount of the sprocket 55 can be accurately corrected.

When the sprocket 55 is rotated, the carrier tape body 91 engaged with the teeth 55a of the sprocket 55 through intermediation of the engagement holes 93 is fed to the front side along with rotation of the sprocket 55.

When the carrier tape body 91 is fed, the electronic component 3 is supplied to the position of the supply window 22 (between the first tape holder 80a and the second tape holder 80b), and the mounting head 30 sucks, with the suction nozzle 31, the electronic component 3 supplied to the position of the supply window 22. In order to additionally supply the electronic components 3 to the mounting head 30, the operation described above is additionally repeated.

When the carrier tape body 91 is fed to the front side, the cover tape 94 is peeled off from the carrier tape body 91 by the spring member 76 configured to pull the tensioner body 71 downward. When the cover tape 94 is peeled off from the carrier tape body 91, the tension applied to the cover tape 94 is gradually reduced. Simultaneously, the tensioner body 71 is rotated clockwise (refer to FIG. 7), which causes the sensor dog 75 to come to the position between the light emitting portion 78 and the light receiving portion 79 of the sensor 77. In this way, the light beam emitted from the light emitting portion 78 is interrupted by the sensor dog 75. As a result, detection of the light beam emitted from the light emitting portion 78 by the light receiving portion 79 is interrupted.

When the light reception mode of the light receiving portion 79 is switched to the non light reception mode, the control unit 81 recognizes that the slack of the cover tape 94 has occurred, and starts rotation of the pulling-in motor 61. When the rotation of the pulling-in motor 61 is started, the rotation of the pulling-in motor 61 is transmitted to the first pull-in roller 64 through intermediation of the first gear 62 and the second gear 63. During the transmission to the first pull-in roller 64, the rotation of the pulling-in motor 61 is slowed down by the first gear 62. With this, a rotational amount of the first pull-in roller 64 can be accurately controlled.

When the first pull-in roller 64 is rotated, the second pull-in roller 65 meshed with the first pull-in roller 64 is rotated along therewith. In this way, the cover tape 94 nipped between the first pull-in roller 64 and the second pull-in roller 65 is pulled in to the rear side. The cover tape 94 pulled in to the rear side is delivered to the cover tape delivery unit (not shown).

When the cover tape 94 is pulled in to the rear side by the first pull-in roller 64 and the second pull-in roller 65, along with this operation, the tension applied to the cover tape 94 becomes higher, which causes the tensioner body 71 to be rotated counterclockwise (refer to FIG. 6). When the tension applied to the cover tape 94 reaches a predetermined magnitude or greater, the sensor dog 75 is moved to a position out of between the light emitting portion 78 and the light receiving portion 79 of the sensor 77. In this way, a state in which the sensor dog 75 has interrupted the light beam emitted from the light emitting portion 78 is cancelled, and the light beam emitted from the light emitting portion 78 is received by the light receiving portion 79.

When the non light reception mode of the light receiving portion 79 is switched to the light reception mode in this way, the control unit 81 recognizes that the slack of the cover tape 94 has been removed, and stops the rotation of the pulling-in motor 61. Subsequently, this series of operations is repeated.

[Operation at Time when Operator Sets Carrier Tape 90 to Tape Cassette 21]

Next, description is made of an operation at a time when the operator sets the carrier tape 90 to the tape cassette 21.

At the time of setting the carrier tape 90 to the tape cassette 21, first, the operator peels off the cover tape 94 from the carrier tape body 91 by an amount of a predetermined length at a leading end portion of the carrier tape 90. After peeling off the cover tape 94, the operator sets the carrier tape body 91 to the tape holder 80, and engages the engagement holes 93 of the carrier tape body 91 with the teeth 55a of the sprocket 55.

Next, the operator grips and inserts the tape cassette 21 into the mounting apparatus 100. In this way, the tape cassette 21 is set to the mounting apparatus 100.

After the tape cassette 21 has been set to the mounting apparatus 100, the first connector 84 of the tape cassette 21 is inserted to the second connector on the mounting apparatus 100 side. In this way, the first connector 84 is connected to the second connector. The control unit 81 monitors whether or not the first connector 84 has been connected to the second connector. When detecting that the first connector 84 has been connected to the second connector, the control unit 81 starts the rotation of the pulling-in motor 61. In this way, the rotation of the pair of pull-in rollers 66 is started.

Next, the operator reverses the cover tape 94 peeled off from the carrier tape body 91 to the rear side, and sets the cover tape 94 to be guided via the upper side of the first guide roller 72, the lower side of the second guide roller 73, and the upper side of the third guide roller 74 of the tensioner 70. This operation of setting the cover tape 94 to be guided via these guide rollers may be performed prior to the insertion of the tape cassette 21 to the mounting apparatus 100.

Next, the operator inserts the leading end of the cover tape 94 to the insertion port 86 provided through the cover member 85 arranged on the front side with respect to the pair of pull-in rollers 66. At this time, the cover member 85 prevents the fingers of the operator from being caught between the pair of pull-in rollers 66 during rotation. When the leading end portion of the cover tape 94 is inserted to the insertion port 86, the pair of pull-in rollers 66 that has already started to be rotated pulls in the cover tape 94 to the rear side with respect to the pair of pull-in rollers 66.

When the cover tape 94 is pulled in to the rear side by the first pull-in roller 64 and the second pull-in roller 65, along with this operation, the tension applied to the cover tape 94 becomes higher, which causes the tensioner body 71 to be rotated counterclockwise (refer to FIG. 6). When the tension applied to the cover tape 94 reaches a predetermined magnitude or greater, the state in which the sensor dog 75 has interrupted the light beam emitted from the light emitting portion 78 is cancelled. As a result, the light beam emitted from the light emitting portion 78 is received by the light receiving portion 79.

When the non light reception mode of the light receiving portion 79 is switched to the light reception mode in this way, the control unit 81 recognizes that the slack of the cover tape 94 has been removed, and stops the rotation of the pulling-in motor 61. In this way, the setting of the carrier tape 90 with respect to the tape cassette 21 is automatically completed.

[Actions]

By the method of setting the carrier tape 90 according to this embodiment, the operator can automatically start the rotation of the pair of pull-in rollers 66 simply by setting the tape cassette 21 to the mounting apparatus 100. Specifically, at the time of setting the cover tape 94, the operator only has to insert the leading end portion of the cover tape 94 to between the pair of pull-in rollers 66 that has already been rotated. With this, the cover tape 94 is automatically pulled in by the pair of pull-in rollers 66, and hence the slack of the cover tape 94 is automatically removed. In this way, by the method of the carrier tape 90 according to this embodiment, the operator can easily set the carrier tape 90 to the tape cassette 21.

Further, in this embodiment, the cover member 85 (restricting member 85) restricts the direct manual access by the operator with respect to the pair of pull-in rollers 66 during rotation, and hence safety for the hand of the operator can be secured.

<Various Modifications>

In the case describe above in this embodiment, the rotation of the pair of pull-in rollers 66 is started when the first connector 84 of the tape cassette 21 is inserted to the second connector on the mounting apparatus 100 side. However, the rotation of the pair of pull-in rollers 66 (needs not be started in response to the connection of the first connector 84 and) may be started by the operation to the operation unit 83 by the operator. In this case, the operator only has to press the roller rotation button 83c of the operation unit 83 after inserting the tape cassette 21 to the mounting apparatus 100. Also in this case, when the operator simply inserts the leading end portion of the cover tape 94 to between the pair of pull-in rollers 66 that has already been rotated, the cover tape 94 is automatically pulled in by the pair of pull-in rollers 66. In this way, the slack of the cover tape 94 is automatically removed.

Incidentally, in the first embodiment described above, immediately after the tape cassette 21 has been inserted to the mounting apparatus 100 (first connector 84 has been inserted to the second connector) and the rotation of the pair of pull-in rollers 66 has been started, the operator may not intend to set the cover tape 94 of the carrier tape 90. For example, after inserting the tape cassette 21 to the mounting apparatus 100, the operator may perform operations other than the operation of setting the carrier tape 90 to the tape cassette 21. Alternatively, for example, for the purpose of storing the tape cassette 21, the operator may insert a tape cassette 21 that has not contained a carrier tape 90 (empty tape cassette 21) to an empty space in the mounting apparatus 100.

In the mounting apparatus 100 described above, when the sensor 77 detects that the tension applied to the cover tape 94 has reached a predetermined magnitude or greater (the slack has been removed), the rotation of the pair of pull-in rollers 66 is automatically stopped. Thus, when no measure is taken, the pair of pull-in rollers 66 is endlessly rotated in the cases where the operator does not intend to immediately set the carrier tape 90. As a result, electric power is wasted.

As a countermeasure, when the sensor 77 does not detect that the tension applied to the cover tape 94 has reached a predetermined magnitude or greater even after elapse of a predetermined time period after the start of the rotation of the pair of pull-in rollers 66, the control unit 81 may execute a process of stopping the rotation of the pair of pull-in rollers 66 after the elapse of the predetermined time period after the start of the rotation of the pair of pull-in rollers 66.

In this case, the control unit 81 starts time counting when the first connector 84 of the tape cassette 21 is connected to the second connector on the mounting apparatus 100 side and the rotation of the pair of pull-in rollers 66 is started. Then, the control unit 81 stops the rotation of the pair of pull-in rollers 66 when the sensor 77 does not detect that the tension applied to the cover tape 94 has reached a predetermined magnitude or greater even after the elapse of the predetermined time period after the start of the time counting (when the non light reception mode of the light receiving portion 79 is not switched to the light reception mode). Only with this, the endless rotation of the pair of pull-in rollers 66 is prevented without detecting, with the sensor 77, whether or not the tension applied to the cover tape 94 has reached a predetermined magnitude or greater (whether or not the slack has been removed). As a result, electric power is saved. Although the above-mentioned predetermined time period is set typically to approximately 30 seconds, this time period may be appropriately changed.

Note that, when the operator intends to stop the rotation of the pair of pull-in rollers 66 within the above-mentioned predetermined time period, the operator can stop the rotation of the pair of pull-in rollers 66 by pressing the roller rotation button 83c of the operation unit 83.

In this context, description is made on the premise that the operator sets the carrier tape 90 to the tape cassette 21 after the rotation of the pair of pull-in rollers 66 has been stopped after the elapse of the above-mentioned predetermined time period or stopped by the operation of the roller rotation button 83c within the above-mentioned predetermined time period. In this case, first, the operator presses the roller rotation button 83c, or once detaches the tape cassette 21 from the mounting apparatus 100 and then reset the tape cassette 21 to the mounting apparatus 100. With this, the rotation of the pair of pull-in rollers 66 is restarted. After that, when the operator inserts the leading end portion of the cover tape 94 to between the pair of pull-in rollers 66 that has already been rotated, the cover tape 94 is automatically pulled in by the pair of pull-in rollers 66. In this way, the slack of the cover tape 94 is automatically removed.

In the above description, although the tensioner 70 and the sensor 77 form a tension applying mechanism configured to apply tension to the cover tape 94, alternatively, there may be employed the following configurations.

(1) Using a direct current (DC) motor as the pulling-in motor 61 and driving the DC motor with a constant current so that constant torque is generated and applied as tension to the cover tape 94.

(2) Providing a torque limiter in the first pull-in roller 64 or in a rotation transmission mechanism provided between the pulling-in motor 61 and the first pull-in roller 64 so that constant torque is generated and applied as tension to the cover tape 94.

In the first embodiment described above, the first connector 84 is connected to the second connector (not shown) of the mounting apparatus 100 so that electric power is supplied to the tape cassette 21 and that the pair of pull-in rollers 66 is rotated. Alternatively, a replacement carriage detachable with respect to the mounting apparatus 100 may be provided to transmit the electric power supplied from the mounting apparatus 100 to the tape cassette 21.

Specifically, a connector configured to supply electric power to the first connector 84 may be provided in advance to the replacement carriage so that the electric power is supplied from the connector of the replacement carriage to the tape cassette 21 through the first connector 84. With such a configuration, during the operation of the mounting apparatus 100, setting of a plurality of tape cassettes can be completed on an outside of the mounting apparatus 100.

Still alternatively, electric power may be supplied to the tape cassette 21 by connecting the first connector 84 to a jig prepared to supply electric power. In this case, the tape cassette 21 to which the cover tape 94 has already been set can be attached to the mounting apparatus 100 or the replacement carriage (not shown). Thus, a degree of freedom in a tape cassette attachment operation becomes higher.

The present technology may employ the following configurations.

(1) A method of setting a carrier tape, the carrier tape including

a carrier tape body configured to contain a plurality of electronic components, and

a cover tape configured to cover the carrier tape body, the method including:

starting rotation of a pair of rollers capable of nipping the cover tape of the carrier tape; and

inserting a leading end portion of the cover tape to between the pair of rollers during the rotation so that the cover tape is pulled in by the pair of rollers.

(2) The method of setting the carrier tape according to Item (1), in which the starting of the rotation of the pair of rollers includes inserting a first connector of a tape cassette to a second connector of a mounting apparatus, the carrier tape being set to the tape cassette, the tape cassette being set to the mounting apparatus.
(3) The method of setting the carrier tape according to Item (1), in which the starting of the rotation of the pair of rollers includes operating an operation unit configured to start the rotation of the pair of rollers.
(4) The method of setting the carrier tape according to any one of Items (1) to (3), further including stopping the rotation of the pair of rollers when a sensor configured to detect whether or not tension applied to the cover tape has reached a predetermined magnitude or greater detects that the tension applied to the cover tape has reached the predetermined magnitude or greater.
(5) The method of setting the carrier tape according to Item (4), in which the stopping of the rotation of the pair of rollers includes stopping the rotation of the pair of rollers after elapse of a predetermined time period after the starting of the rotation of the pair of rollers when the sensor does not detect that the tension applied to the cover tape has reached the predetermined magnitude or greater even after the elapse of the predetermined time period after the starting of the rotation of the pair of rollers.
(6) The method of setting the carrier tape according to any one of Items (1) to (5), in which the inserting of the leading end portion of the cover tape to between the pair of rollers during the rotation so that the cover tape is pulled in by the pair of rollers includes inserting the leading end portion of the cover tape to between the pair of rollers during the rotation through intermediation of a restricting member configured to restrict direct manual access by an operator with respect to the pair of rollers during the rotation.
(7) A tape cassette, including a pair of rollers capable of nipping a cover tape of a carrier tape including

a carrier tape body configured to contain a plurality of electronic components, and

the cover tape configured to cover the carrier tape body and including a leading end portion, the leading end portion of the cover tape being inserted to between the pair of rollers during rotation so that the inserted cover tape is pulled in by the pair of rollers.

(8) The tape cassette according to Item (7), further including:

a first connector configured to be inserted to a second connector of a mounting apparatus to which the tape cassette is set; and

a control unit configured to start the rotation of the pair of rollers when the first connector is inserted to the second connector.

(9) The tape cassette according to Item (7), further including an operation unit configured to start the rotation of the pair of rollers.
(10) The tape cassette according to any one of Items (7) to (9), further including:

a sensor configured to detect whether or not tension applied to the cover tape has reached a predetermined magnitude or greater; and

a control unit configured to stop the rotation of the pair of rollers when the sensor detects that the tension applied to the cover tape has reached the predetermined magnitude or greater.

(11) The tape cassette according to Item (10), in which the control unit stops the rotation of the pair of rollers after elapse of a predetermined time period after starting of the rotation of the pair of rollers when the sensor does not detect that the tension applied to the cover tape has reached the predetermined magnitude or greater even after the elapse of the predetermined time period after the starting of the rotation of the pair of rollers.
(12) The tape cassette according to any one of Items (7) to (11), further including a restricting member configured to restrict direct manual access by an operator with respect to the pair of rollers during the rotation.
(13) A mounting apparatus, including a tape cassette including a pair of rollers capable of nipping a cover tape of a carrier tape including

a carrier tape body configured to contain a plurality of electronic components, and

the cover tape configured to cover the carrier tape body and including a leading end portion, the leading end portion of the cover tape being inserted to between the pair of rollers during rotation so that the inserted cover tape is pulled in by the pair of rollers.

(14) A method of manufacturing a substrate, including:

starting rotation of a pair of rollers capable of nipping a cover tape of a carrier tape including
a carrier tape body configured to contain a plurality of electronic components, and
the cover tape configured to cover the carrier tape body,

inserting a leading end portion of the cover tape to between the pair of rollers during the rotation so that the cover tape is pulled in by the pair of rollers, to thereby supply the plurality of electronic components from the carrier tape set to a tape cassette; and

mounting the plurality of supplied electronic components to the substrate.

The present disclosure contains subject matter related to that disclosed in Japanese Priority Patent Application JP 2012-071786 filed in the Japan Patent Office on Mar. 27, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A method of setting a carrier tape, the carrier tape including
a carrier tape body configured to contain a plurality of electronic components, and
a cover tape configured to cover the carrier tape body, the method comprising:
starting rotation of a pair of rollers capable of nipping the cover tape of the carrier tape; and
inserting a leading end portion of the cover tape to between the pair of rollers during the rotation so that the cover tape is pulled in by the pair of rollers.

2. The method of setting the carrier tape according to claim 1, wherein the starting of the rotation of the pair of rollers includes inserting a first connector of a tape cassette to a second connector of a mounting apparatus, the carrier tape being set to the tape cassette, the tape cassette being set to the mounting apparatus.

3. The method of setting the carrier tape according to claim 1, wherein the starting of the rotation of the pair of rollers includes operating an operation unit configured to start the rotation of the pair of rollers.

4. The method of setting the carrier tape according to claim 1, further comprising stopping the rotation of the pair of rollers when a sensor configured to detect whether or not tension applied to the cover tape has reached a predetermined magnitude or greater detects that the tension applied to the cover tape has reached the predetermined magnitude or greater.

5. The method of setting the carrier tape according to claim 4, wherein the stopping of the rotation of the pair of rollers includes stopping the rotation of the pair of rollers after elapse of a predetermined time period after the starting of the rotation of the pair of rollers when the sensor does not detect that the tension applied to the cover tape has reached the predetermined magnitude or greater even after the elapse of the predetermined time period after the starting of the rotation of the pair of rollers.

6. The method of setting the carrier tape according to claim 1, wherein the inserting of the leading end portion of the cover tape to between the pair of rollers during the rotation so that the cover tape is pulled in by the pair of rollers includes inserting the leading end portion of the cover tape to between the pair of rollers during the rotation through intermediation of a restricting member configured to restrict direct manual access by an operator with respect to the pair of rollers during the rotation.

7. A tape cassette, comprising a pair of rollers capable of nipping a cover tape of a carrier tape including
a carrier tape body configured to contain a plurality of electronic components, and
the cover tape configured to cover the carrier tape body and including a leading end portion, the leading end portion of the cover tape being inserted to between the pair of rollers during rotation so that the inserted cover tape is pulled in by the pair of rollers.

8. The tape cassette according to claim 7, further comprising:
a first connector configured to be inserted to a second connector of a mounting apparatus to which the tape cassette is set; and
a control unit configured to start the rotation of the pair of rollers when the first connector is inserted to the second connector.

9. The tape cassette according to claim 7, further comprising an operation unit configured to start the rotation of the pair of rollers.

10. The tape cassette according to claim 7, further comprising:
a sensor configured to detect whether or not tension applied to the cover tape has reached a predetermined magnitude or greater; and
a control unit configured to stop the rotation of the pair of rollers when the sensor detects that the tension applied to the cover tape has reached the predetermined magnitude or greater.

11. The tape cassette according to claim 10, wherein the control unit stops the rotation of the pair of rollers after elapse of a predetermined time period after starting of the rotation of the pair of rollers when the sensor does not detect that the tension applied to the cover tape has reached the predetermined magnitude or greater even after the elapse of the predetermined time period after the starting of the rotation of the pair of rollers.

12. The tape cassette according to claim 7, further comprising a restricting member configured to restrict direct manual access by an operator with respect to the pair of rollers during the rotation.

13. A mounting apparatus, comprising a tape cassette including a pair of rollers capable of nipping a cover tape of a carrier tape including
a carrier tape body configured to contain a plurality of electronic components, and
the cover tape configured to cover the carrier tape body and a leading end portion, the leading end portion of the cover tape being inserted to between the pair of rollers during rotation so that the inserted cover tape is pulled in by the pair of rollers.

14. A method of manufacturing a substrate, comprising:
starting rotation of a pair of rollers capable of nipping a cover tape of a carrier tape including
a carrier tape body configured to contain a plurality of electronic components, and
the cover tape configured to cover the carrier tape body,
inserting a leading end portion of the cover tape to between the pair of rollers during the rotation so that the cover tape is pulled in by the pair of rollers, to thereby supply the plurality of electronic components from the carrier tape set to a tape cassette; and
mounting the plurality of supplied electronic components to the substrate.
